(19) United States
(12) Patent Application Publication
(10) Pub. No.: US 2007/0015675 A1
(43) Pub. Date: Jan. 18, 2007

(54) Self-pressurized spray stain remover

(76) Inventors: Jeffrey Donald Painter, Loveland, OH (US); Michael Ray McDonald, Middletown, OH (US); Peter Robert Foley, Cincinnati, OH (US); Michael Vincent Nario Malanyaon, Indian Springs, OH (US); John Habib Nackhla, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/471,251

(22) Filed: Jun. 20, 2006

Related U.S. Application Data
(60) Provisional application No. 60/699,798, filed on Jul. 15, 2005.

(51) Int. Cl. C11D 3/37

(52) U.S. Cl. 510/276

(57) ABSTRACT

Self-pressurized spray product for removing stains from textiles. Also disclosed is a method for removing stains from textiles. The self-pressurized spray product is designed to deliver a directed product stream. When directed at textile stains, the product stream does not obscure the user's vision of the stain with foam during treatment and further enables the user to observe stain removal during application of the product stream to the stain.

### CROSS REFERENCE TO RELATED APPLICATION

This application claims the benefit of U.S. Provisional Patent Application Ser. No. 60/699,798, filed Jul. 15, 2005.

### FIELD OF THE INVENTION

The present invention relates to self-pressurized products for removing stains from textiles and methods for doing the same. The present invention further relates to laundry stain removal products.

### BACKGROUND OF THE INVENTION

One of the drawbacks of using stain removers to remove stains from textiles (including but not limited to garments) is the need to rub and/or scrub the textile after the stain removal product has been applied to the stain. This tends to require quite a bit of effort on the part of the user. Further, the rubbing and scrubbing can result in degradation of the textile. A further drawback is the inability of the user to view removal of the stain during the stain removal treatment process because the user must either scrub the stained area during treatment and/or because the stain removal product forms an obscuring foam as it is applied to the stain both of which obscure the user's ability to view the stain removal process.

Accordingly, there is a need for a stain removal product that removes that removes stains from textiles, without requiring rubbing and scrubbing during the stain removal treatment process. Furthermore, there is a need for a stain removal product which enables the user to view the removal of the stain from the textile during the application of the stain removal product to the textile. Yet further there is a need for a stain removal product which works on the spot to quickly and effectively remove stains from textiles.

The present invention addresses these needs by providing a stain removal product which removes stains from textiles with minimal rubbing or scrubbing. Furthermore, the present invention allows the user to apply a stain removal product which does not form an obscuring foam on the textile thereby allowing the user to view the stain removal process as it occurs. In addition, one of the unexpected benefits of the present invention is that the user can watch the stain remover work on the spot to dissipate the stain as the stain removal product is being applied to the stain thereby providing a quick and efficient way to remove stains from textiles.

### SUMMARY OF THE INVENTION

The present invention relates to a self-pressurized spray product for removing stains from textiles. The self-pressurized spray product comprises:

a) a pressurized dispensing container;

b) a propellant;

c) an aqueous stain removal formulation containing at least about 5% by weight of a non-aqueous solvent, at least about 30% by weight of water and having a surface tension of about 45 dynes/cm² or less, an initial SITA foam height of about 260 ml or less, and a decayed SITA foam height after 2 minutes of about 25 ml or less; and

d) an actuator having a nozzle and a valve stem assembly connected thereto whereby the aqueous stain removal formula is discharged from the pressurized dispensing container through the nozzle in the form of a spray. The delivery rate of the spray from the nozzle is from about 0.25 g/sec to about 4 g/sec. The spray as it is discharged from the pressurized dispensing container forms a spray angle of about 10° or less. The spray has an impact pressure on the surface of the stain of about 1 kPa or more.

The present invention further relates to a system for removing stains from textiles.

The system comprises:

a) a self-pressurized spray product wherein the self-pressurized spray product comprises:
i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less, and a decayed SITA foam height after 2 minutes of about 25 ml or less; and
   iv) an actuator having a nozzle and a valve stem assembly connected thereto whereby the aqueous stain removal formula is discharged from the pressurized dispensing container through the nozzle in the form of a spray, wherein the delivery rate of the spray from the nozzle is about 0.5 g/sec to about 4 g/sec; and

b) a washing appliance, a refreshing appliance, or a combination thereof.

In yet another aspect, the present invention relates to a self-instructing article of commerce, wherein the self-instructing article of commerce comprises:

a) a self-pressurized spray product for removing stains from textiles, the self-pressurized spray product comprising:

i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less, and a decayed SITA foam height after 2 minutes of about 25 ml or less; and
iv) an actuator having a nozzle and a valve stem assembly connected thereto whereby the aqueous stain removal formula is discharged from the pressurized dispensing container through the nozzle in the form of a spray, wherein the delivery rate of the spray from the nozzle is about 0.25 g/sec to about 4 g/sec; and
   b) a set of instructions, included in association with the self-pressurized spray product wherein the set of instructions directs a user to follow the method of removing stains from textiles with the self-pressurized spray product.

In a further aspect, the present invention relates to a method of removing stains from textiles. The method comprises the steps of:

a) providing a self-pressurized spray product for removing stains from textiles wherein the self-pressurized spray product comprises:

i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less and a decayed SITA foam height after 2 minutes of about 25 ml or less; and
iv) an actuator having a nozzle and a valve stem assembly connected thereto;
   b) activating said actuator so as to discharge the aqueous stain removal formula in the form of a spray from the pressurized dispensing container through the nozzle at a delivery rate from the nozzle of about 0.25 g/sec to about 4 g/sec;
   c) contacting a textile stain with the spray wherein the impact pressure of the spray on the stain is about 1 kPa or more.

### DETAILED DESCRIPTION OF THE INVENTION

The present invention relates to a self-pressurized spray product for removing stains from textiles. Additionally, the present invention relates to a spray product which dispels stains quickly and efficiently as it is being applied to the stain so as to provide “before your eyes” stain dissipation. The present invention further relates to methods for removing stains from textiles. In one non-limiting embodiment the product may be used for removing stains from fabrics. If desired, the product may either be used alone to remove stains from textiles and/or as part of a system for removing stains. For instance, in one non-limiting example, the product may be used as a pretreater to remove stains from fabric prior to laundering. Reference will now be made in detail to various embodiments of the present invention. All percentages, ratios, and proportions herein are on a weight basis unless otherwise indicated. Except as otherwise noted, all amounts including quantities, percentages, portions, and proportions, are understood to be modified by the word “about”, and amounts are not intended to indicate significant digits. Except as otherwise noted, the articles “a”, “an”, and “the” mean “one or more”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The self-pressurized spray product of the present invention comprises:
(1) A dispensing container, capable of sustaining the desired pressure inside the container without bursting or deforming;
(2) a propellant;
(3) An aqueous stain removal formulation containing at least one non-aqueous solvent; and
(4) a valve, nozzle orifice, and actuator assembly which, when actuated, delivers a highly directed stream having the following properties:

a. a mass delivery rate between about 0.5 and about 4 grams/second;

b. spray angle at the final orifice of about 10 degrees or less; and

c. an impact pressure of at least about 2 kPa;

such that the stain being treated is not obscured from view during treatment with the product.

Each component is described more fully below.

Pressurized Dispensing Container

The dispensing container of the present invention can be any suitable container for holding ingredients under the pressure created by a propellant, typically referred to as an aerosol container. The design of such containers in the form of metal cans is well known, including both steel (tinplate) and aluminum aerosol containers. More recently, even plastic containers have been developed which can be used to maintain the pressure created by a propellant inside the container.

As an aerosol container is a pressurized container, specifications for such containers are regulated in many countries according to the pressure being contained. This has resulted in a number of standard industry specifications for aerosol containers. For example, standard aerosol containers in the United States are typically classified as either nonspecification, 2P or 2Q containers. These specifications designate minimum buckle and burst pressures and a minimum wall thickness for the containers. For instance, aerosol products that exhibit a pressure of less than 1070 kilopascals (“kPa”) at 54.5° C. (130° F.) are classified as nonspecification containers and are typically not identified. Aerosol systems that exhibit a pressure at 54.5° C. between 1070 kPa and 1200 kPa are required to use a can construction having a 2P specification or higher. Aerosol systems that exhibit a pressure at 54.5° C. between 1200 kPa and 1340 kPa are typically required to use a can construction having a 2Q specification or higher. Similar standards exist in Europe with alternative designations including the 12 bar and 18 bar can standards. These industry standards have been developed to maintain tight control on the construction of aerosol containers.

For the present invention, aluminum cans meeting a 2Q specification are desirable. Such cans support the higher can pressures needed to achieve a highly directed product stream for quick and efficient “before your eyes” textile stain removal which occurs as the user applies the product to the stain. Such cans can be obtained from numerous manufacturers of aerosol containers, including, but not limited to, CCL Container Aerosol Division, of Hermitage, Pa. or Exal Container of Youngstown, Ohio.

The dispensing container can be of any suitable shape, with a cylindrical shape and orientation being commonly used for manufacturing and marketing reasons. Aerosol cans of this shape are well known in the industry. In fact, industry standard can dimensions have also been established providing a range of stock can sizes. These cans are typically specified according to the overall diameter and the overall height of the can. Necked cans, wherein the container tapers inwardly towards the upper portion of the can, are commonly used. Cans with shoulders may also be used. The container can have numerous shapes in different embodiments, but a necked cylindrical can shape tends to be ergonomically desirable. In one non-limiting embodiment of the present invention, a necked cylindrical can shape having a 59 mm diameter and a height of about 200 mm may be used.

Most cans include coatings or liners to help protect the container from corrosion and the product from any possible chemical reaction with the container itself. Even slight reactions between the product in the container and the container metallurgy can give rise to fragrance changes, color changes, loss of chemical activity of critical components, and even over-pressure conditions through reactions which create additional gas. Hence, the industry has developed a range of coatings and liners to prevent such interactions. These include but are not limited to enamels and liners made from the following kinds of resins: acrylic, maleic, polyamide imide, alkyd, vinyl, polybutadiene, phenolic, epoxy-amine, epoxy-ester, epoxy-phenolic, oleoresin, and others. The choice of coating or liner depends on the product characteristics and the metallurgy of the aerosol container. One embodiment which uses a polyamide imide liner coating is sold as PAM 8460N, available from PPG Packaging Coatings, HOBA Division, of Grabenstrabe, Germany.

Propellant

The propellant of the present invention is capable of sustaining a full can pressure at 70° F. (21° C.) above 50 psig (446 kPa) and above 40 psig (377 kPa) after 75% of the formula has been used. The propellant can be selected from among the numerous propellants commonly used in the aerosol industry. These are typically classified as either liquefied gas propellants or compressed gas propellants. Suitable compressed gas propellants include, but are not limited to, compressed air, nitrogen, nitrous oxide, carbon dioxide, and mixtures thereof. Suitable liquefied gas propellants include, but are not limited to, hydrocarbon propellants such as propane, isobutane, isopropane, isobutene, n-butane, dimethyl ether (“DME”), and mixtures thereof, and hydrofluorocarbons such as HFC 152a and HFC 134a.

The choice of propellant is a major factor influencing the gas pressure inside the can which in turn influences the delivery rate and impact pressure associated with the spray upon actuation of the valve. In certain embodiments, liquefied gas propellants may be preferred over compressed gas propellants because they tend to better maintain the pressure inside the can throughout the use of the product, because as the liquid phase propellant boils off to maintain pressure as the gas volume of the can increases due to product consumption. While not wishing to be limited by theory, it is believed that this may be a reason why, the present invention tends to provide more consistent results throughout the usage of the product when a liquefied gas propellant is used.

Propellants are commonly mixed to achieve the desired can pressure. Mixtures of propellants can contain propane, isobutane, and n-butane. In various embodiments of the present invention, mixtures of propane and isobutane having a vapor pressure at 70° F. between about 70 psig and about 100 psig may be desirable. In one non-limiting embodiment of the present invention a common blend of propane and isobutane referred to as Aeron A85, and available from Diversified CPC International, Inc. of Channahon, Ill., USA, may be used. This blend comprises 68.9 mol % propane and 31.1 mol % isobutane and provides a vapor pressure at 70° F. of 85 psig.

Optionally, in cases where excessive interaction between the propellant and product needs to be avoided, barrier packaging systems have been developed to separate the propellant from the product inside the aerosol container. These include piston barrier packaging and bag-in-can packaging, such as the ABS® Advanced Barrier System available from CCL Container, Advance Monobloc Aerosol Division of Hermitage, Pa. In some embodiments, these barrier packaging approaches can be employed to obtain more consistent product properties throughout the usage period of the product. While these barrier systems have some advantages, they are costly and need not be used to obtain the advantages of the present invention.

Aqueous Stain Removal Formulation

The aqueous stain removal formulation of the present invention typically has a surface tension of about 45 dynes/cm² or less, or from about 10 dynes/cm² to about 45 dynes/cm², or from about 15 dynes/cm² to about 35 dynes/cm². The aqueous stain removal formulation produces an initial SITA foam height of about 260 ml or less, or about 150 ml or less, or about 100 ml or less, or about 0 ml and a decayed foam height after 2 minutes of about 25 ml or less, about 15 ml or less, or about 0 ml. The aqueous stain removal formulation typically comprises: (a) at least about 30% water by weight, or from about 30% to about 90% water by weight, or from about 40% to about 85% water by weight, or from about 50% to about 80% water by weight; (b) at least about 5% by weight of one or more organic solvents, or from about 5% to about 50% organic solvent by weight, or from about 10% to about 45% organic solvent by weight, or from about 15% to about 40% organic solvent by weight; and (c) about 2% or less of surfactant by weight, or from about 0% to about 2% surfactant by weight, or from about 0.001% to about 0.5% surfactant by weight. Other ingredients may also be added, including but not limited hydrotropes, defoamers, suds suppressors, perfumes, reducing agents, chelating agents, and mixtures thereof.

Water:

The water content of the aqueous stain removal formulation of the present invention typically comprises about 30% or more, or about 50% or more of the aqueous stain removal formulation. While not wishing to be limited by theory it is believed that this level of water helps facilitate hydrophilic stain removal across a broad spectrum of stains. Deionized water or water with a low mineral content is generally preferred in order to minimize the deposit of hard water salts on the fabrics being cleaned or to mimimize any potential blocking of the actuation mechanism.

Solvent:

Suitable solvents useful in the aqueous stain removal formulation of the present invention include but are not limited to alcohols, glycols, glycol ethers, amines, esters, terpenes and mixtures thereof. Examples of suitable solvents are the lower molecular weight alcohols, the lower molecular weight alkyl glycols, and the lower molecular weight alkyl ketones. Suitable lower alcohols include those containing from about 2 to about 4 carbon atoms such as ethanol, n-propanol, isopropanol, n-butanol, and isobutanol. These alcohols are soluble or miscible in water and help promote the formation of homogeneous solutions other solvent ingredients in the compositions of the present invention. Suitable lower molecular weight alkyl ketones include those containing from about 2 to about 6 carbon atoms such as acetone and methyl isobutyl ketone. Of these solvents, ethanol and isopropanol, or mixtures thereof, are preferred.

Other suitable solvents include glycol and glycol ether solvents, including alkyl glycols, polyalkylene glycols, glycol ethers, glycol esters and mixtures thereof. Suitable alkyl glycols are those containing from about 2 to about 6 carbon atoms such as ethylene glycol, 1,2-propylene glycol and 1,2-hexylene glycol. In typical compositions of the present invention the organic solvent comprises a mixture of glycol ether solvents selected from the group including monoethylene glycol ethers and acetates, diethylene glycol ethers and acetates, monopropylene glycol ethers and acetates, and dipropylene glycol ethers, acetates, and diethers. These materials are commonly marketed under such trademarks as CARBITOL®, CELLOSOLVE®, DOWANOL®, ARCOSOLV®, and PROPASOL® all of which are available from Dow Chemical Company of Midland, Mich. Suitable glycol ethers include ethylene glycol monobutyl ether, diethylene glycol monobutyl ether, ethylene glycol propyl ether, diethylene glycol propyl ether, diesthylene glycol n-butyl ether, diethylene glycol n-butyl ether acetate, ethylene glycol monomethyl ether, ethylene glycol monoethyl ether, diethylene glycol monomethyl ether, diethylene glycol monoethyl ether, propylene glycol monobutyl ether, dipropylene glycol monobutyl ether, ethylene glycol phenyl ether, propylene glycol n-propyl ether, propylene glycol methyl ether acetate, propylene glycol diacetate, dipropylene glycol methyl ether, and mixtures thereof. Preferred glycol ethers are dipropylene glycol monobutyl ether, and propylene glycol monobutyl ether.

Other suitable solvents include: terpineol, 2-methyl-2,4-pentanediol, 1-,2-hexanediol, Glycerin, 1-t-butoxy-2-propanol, 2-methyoxyethanol, UCAR® FILMER IBT, UCAR® ESTER EEP (both of which are available from Dow Chemical Company of Midland Mich.), and 2-ethylhexanol.

Suitable organoamine cleaning solvents include alkanolamines, alkylamines, alkyleneamines and mixtures thereof. Preferred organoamine solvents for use herein are alkanolamines, especially monoethanol amine, methyl amine ethanol and 2-amino-2-methyl-propanol. Highly preferred organoamine solvents include 2-aminoalkanol solvents. Suitable alcoholic cleaning solvents include aromatic, aliphatic and cycloaliphatic alcohols and mixtures thereof.

One non-limiting suitable organic solvent system for use herein has a volatile organic content above 0.1 mm Hg of less than about 50%, or less than about 30%, or less than about 20%.

In terms of solvent parameters, the organic solvent can be selected from:
a) polar, hydrogen-bonding solvents having a Hansen solubility parameter of at least about 20 (Mpa)^{1/2}, a polarity parameter of at least about 7 (Mpa)^{1/2}, or at least about 12 (Mpa)^{1/2}, and a hydrogen bonding parameter of at least about 10 (Mpa)^{1/2};
b) polar non-hydrogen bonding solvents having a Hansen solubility parameter of at least about 20 (Mpa)^{1/2}, a polarity parameter of at least about 7 (Mpa)^{1/2}, or at least about 12 (Mpa)^{1/2} and a hydrogen bonding parameter of at least about 10 (Mpa)^{1/2};
c) amphiphilic solvents have a Hansen solubility parameter below about 20 (Mpa)^{1/2}, a polarity parameter of at least about 7 (Mpa)^{1/2}, or preferably by at least about 12 (Mpa)^{1/2}, and a hydrogen bonding parameter of at least about 10 (Mpa)^{1/2};
d) non-polar solvents having a polarity parameter below about 7 (Mpa)^{1/2}, and a hydrogen bonding parameter below about 10 (Mpa)^{1/2}; and
e) mixtures thereof.

Surfactant:

A surfactant in the amount of about 2% or less by weight, or from about 0% to about 2% surfactant by weight, or from about 0.001% to about 0.5% surfactant by weight may be included in the aqueous stain removal formulation. The surfactant of the may contain all manner of organic, water-soluble surface active agents, typically designated surfactants. While not wishing to be limited by theory, it is believed that the surfactant when used may help facilitate wetting of the aqueous stain removal formulation without obscuring the user's view of the stain while it is being treated. Suitable surfactants useful in the present invention include anionic surfactants, cationic surfactants, nonionic surfactants, amphoteric surfactants, zwitterionic surfactants, and mixtures thereof. Suitable surfactants can be selected from the classes and species of compounds known in the industry, such as those disclosed in U.S. Pat. No. 3,664,961. All manner of surfactants may be used provided that the final aqueous stain removal formulation composition has a surface tension less than about 45 dyne/cm² and an initial SITA foam height of about 260 ml or less which decays to less than about 25 ml or less within 2 minutes.

Suitable surfactants include but are not limited to water soluble nonionic surfactants. Such nonionic materials include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements.

A well known class of nonionic surface active agents is available on the market under the trade name “PLURONIC®” available from BASF Corporation of Florham Park, N.J. These compounds are formed by condensing ethylene oxide with a hydrophobic base formed by the condensation of propylene oxide with propylene glycol. Other suitable nonionic surfactants include the polyethylene oxide condensates of alkyl phenols, e.g., the condensation products of alkyl phenols having an alkyl group containing from about 6 to about 12 carbon atoms in either a straight chain or branched chain configuration, with ethylene oxide, the ethylene oxide being present in amounts equal to 5 to 25 moles of ethylene oxide per mole of alkyl phenol.

The water soluble condensation products of aliphatic alcohols having from about 8 to about 22 carbon atoms, in either straight chain or branched configuration, with ethylene oxide, e.g., a coconut alcohol-ethylene oxide condensate having from 5 to 30 moles of ethylene oxide per mole of coconut alcohol, the coconut alcohol fraction having from 10 to 14 carbon atoms, are also useful nonionic surfactant Suitable alcohol ethoxylates are those having from about 10 to about 16 carbon atoms condensed with between 5 and 15 moles of ethylene oxide per mole of alcohol, such as NEODOL® 23-9 from Shell Chemicals in Houston, Tex. or SURFONIC® L24-9 from Huntsman Chemical of Houston, Tex.

Hydrotropes:

In addition to the solvents of the present invention, which can provide some hydrotropic functionality, it has been found that the inclusion of other hydrotropes in the composition can further improve the formulatability of the organic solvents and help achieve an isotropic formulation. A description of hydrotropes suitable for use herein can be found in Chapter 2 (entitled “Hydrotropy”) of Surfactant Science, Vol. 67 “Liquid Detergents”, 1997.

Suitable hydrotropes are selected from ethanol, sodium cumene sulphonate, sodium xylene sulphonate, sodium naphthalene sulphonate, sodium p-toluene sulphonate, C5-C20 polyols and mixtures thereof. Sodium cumene sulphonate is preferred. While the sodium form of the hydrotrope is preferred, the potassium, ammonium, alkanolammonium, and/or C2-C4 alkyl substituted ammonium forms can also be used.

Suitable C5-C20 polyols are those wherein at least two polar groups are separated from each other by at least 5, preferably 6, carbon atoms. Typically, the polyols of the present invention have from about 5 to about 12, or from about 6 to about 10 carbon atoms. Examples of suitable polar groups for inclusion in the C5-C20 polyols include hydroxyl and carboxyl ions. Typically, the polyols of the present invention have from about 2 to about 6, hydroxy groups per molecule. Preferred C5-C20 polyols include 1,4 cyclohexanedimethanol, 1,6 hexanediol, and 1,7 heptanediol. Mixtures of these organic molecules or any number of C5-C20 polyols which comprise two polar groups separated from each other by at least about 5, or about 6, aliphatic carbon atoms are also acceptable.

When present, the a hydrotrope typically will comprise from about 0.01% to about 15% by weight of the aqueous stain removal formulation, or from about 0.1% to about 10% by weight of the aqueous stain removal formulation, or from about 0.25% to about 7% by weight of the aqueous stain removal formulation, or from about 0.5% to about 5% by weight of the aqueous stain removal formulation.

Antifoam Agent:

The compositions herein may also optionally include a silicone antifoam agent for depressing foam formation during spraying. When used, the silicone antifoam will comprise from about 0.005% to about 1% by weight of the aqueous stain removal formulation, or from about 0.01% to about 5% of the aqueous stain removal formulation. Invariably some of the propellant used to create a pressurized container will escape as the product is being used. Since such propellants are gases under typical usage conditions, they can create bubbling or may even tend to create foam as they evaporate upon actuation of the spray. In addition to formulating with low surfactant levels, the addition of a silicone antifoam can help suppress foaming and assure that the stain is not visually obscured by foam during treatment with the product.

Suitable silicone antifoams include but are not limited to polysiloxane materials. One exemplary antifoam is Dow Corning 1520 Silicone Antifoam which is available from Dow Corning of Midland, Mich. It should be noted that other antifoam agents including but not limited to ethanol, fatty acids, or phosphate esters may also be used.

Perfume:

A perfume may optionally be included in the aqueous stain removal formulation of the present invention. When a perfume is used, the compositions herein comprise from about 0.01% to about 0.5% of perfume by weight of the aqueous stain removal formulation, or from about 0.05 to about 0.3%, of perfume by weight of the aqueous stain removal formulation.

Reducing Agent:

The compositions herein may also optionally include a reducing agent which can be useful for treating color based stains. The reducing agents useful with the present invention include those substances that cause other species to be reduced or gain electrons. Suitable reducing agents include the active metals, such as sodium, magnesium, aluminum, and zinc, which have relatively small ionization energies and low electro-negativities. Preferred reducing agents are those which promote the oxidation of stain components in an aqueous solution having a pH between about 4 and about 10, or between about 5 and about 8.

Non-limiting examples of suitable reducing agents include TRIS (2-carboxyethyl) phosphine hydrochloride (TCEP HCl), thioureadioxide, thiosulfate, sulfite, tetraborate, diethyldithiocarbaminate, ethylxantoginate, ascorbic acid and the water soluble salts thereof. A preferred reducing agent is sodium bisulfite (NaHSO₃). Sodium bisulfite is commonly used in the pulp and paper industry to bleach mechanical pulp and is manufactured by absorbing SO₂ in an alkaline solution. When used, the reducing agent is typically incorporated into the aqueous stain removal formulation in an amount of about 0.1% to about 10%, or in an amount of about 0.5% to about 2%, of reducing agent by weight of the composition.

Chelating Agent:

The herein may also optionally include a chelating agent which can be useful for treating metal based stains. A variety of phosphonate chelants may be used including including but not limited to amino phosphonates. Various amino phosphonates are available under the DEQUEST® trade name from Solutia Incorporated of St. Louis, Mo. Representative, but non-limiting examples of other chelating agents include ethylenediamine tetrakis(methylene phosphonic) acid, diethylenetriamine penta(methylene phosphonic) acid, amino tris(methylene phosphonic) acid, hydroxyethylidene 1,1-diphosphonic acid, hexamethylene diamine tetra methylene phosphonic acid, hexamethylene triamine penta methylene phosphonic acid, and the water soluble salts thereof.

The compositions of the present invention may also include minor amounts of other optional ingredients, including but not limited to pH control agents, corrosion inhibitors, preservatives, salts for modifying the ionic strength of the formula, brighteners, and the like. If used, such optional ingredients will typically comprise from about 0.05% to about 2% by weight, of the compositions.

Spray Properties

For a given formula the spray characteristics, including the delivery rate, the spray angle, and the spray velocity are determined by the can pressure, the physical properties of the aqueous stain removal formulation, and the design and mechanics of the aerosol valve and nozzle components. Widely different spray characteristics can be obtained for the same formula using the same propellant and can pressure, making the selection of the valve and nozzle components critical to obtaining the desired properties.

Valves and actuators are well known to those to those of ordinary skill in the art. A valve consists of a series of orifices, expansion chambers, and flow channels, culminating in the final nozzle orifice (nozzle) which is typically part of the actuator. Upon actuation, the valve allows product to flow from the pressurized can through the valve channels and out the final nozzle.

In the present invention, it has been surprisingly found that significant stain removal benefits can be achieved almost instantly during use when the right combination of an aqueous stain removal formulation, propellant, valve, and nozzle are utilized. To achieve the needed spray characteristics, the valve, actuator, and nozzle combination must be carefully selected. The spray properties include a product delivery rate wherein the product delivery rate out of the nozzle is from about 0.25 g/sec to about 4.0 g/sec range, or from about 0.5 g/sec to about 3 g/sec, or from about 1 g/sec to about 2.5 g/sec; a spray angle of about 10 degrees or less, or about 5 degrees or less; and an impact pressure of about 1 kPa or more, or about 5 kPa or more, or about 1 kPa to about 100 kPa, or about 2 kPa to about 80 kPa, or about 5 kPa to about 60 kPa. Delivery rate refers to the quantity of product expelled through the nozzle in a given time. Spray angle refers to the angle of the spray cone formed at the point of discharge from the nozzle. Impact pressure refers to the force exerted on the surface across the area of impact.

Suitable combinations of valves and nozzles are illustrated in the examples below.

System

The self-pressurized spray stain remover article of the present invention may be used alone as a textile stain remover or if desired, it may be used in conjunction with a system for removing stains from fabric. For instance, in one non-limiting example the self-pressurized spray stain remover article may be used in conjunction with a laundry process to remove stains prior to laundering. For example, the self-pressurized spray stain remover could be used in conjunction with a fabric washing appliance including but not limited to a washing machine wherein the fabric is treated with the self-pressurized spray stain remover and then is laundered in a fabric washing machine. Alternatively, after treatment with the self-pressurized spray stain remover the fabric could be refreshed in a refreshing appliance including but not limited to a refreshing cabinet, one non-limiting example of which is disclosed in U.S. Pat. No. 6,726,186. If desired, the self-pressurized spray stain remover article may be used as part of pretreatment process to pretreat stains on fabric prior to laundering and/or refreshing.

Self-Instructing Article of Commerce

The present invention also encompasses a self-pressurized spray stain remover article of commerce. A set of instructions may be included in association with the article which directs the user to follow the method of removing stains from textiles with the article. For instance, in one non-limiting embodiment, such instructions may direct the user to apply the spray to a stained area on a textile. In another non-limiting embodiment, the instructions may direct the user to apply the spray to a stained area on a textile and then proceed with laundering the textile. In yet another embodiment, the instructions may direct the user to apply the spray from a distance of about 2 inches (5.08 cm) to about 3 inches (7.62 cm) from the surface of the stain. In still another embodiment, the instructions may direct the user to focus the spray on the stain and slowly move the spray outwardly from the center of the stain.

Herein, “in association with”, when referring to such instructions, means the instructions are either directly printed on the article; directly printed on the packaging for the article; printed on a label attached to the packaging for the article; or presented in a different manner including, but not limited to, a brochure, print advertisement, electronic advertisement, broadcast or internet advertisements; and/or other media, so as to communicate the set of instructions to a consumer of the article.

Method of Treating Textile Stains With the Self-Pressurized Spray Stain Remover Article of the Present Invention

The present invention also includes a method of use for treating stains on textiles with the self-pressurized spray stain remover article of the present invention. This includes actuating the spray stain remover article so as the spray stream contacts the stain on the textile. The method of use may additionally include, laundering the textile after it is contacted by the article.

### Test Methods

Method for Measuring the Surface Tension of the Aqueous Stain Removal Formulation

A Delta 8 instrumentation unit, (Model MultiPi HTs1A, commercially available from Kibron Inc. of Helsinki, Finland) is used to determine the surface tension of samples of the aqueous stain removal formulation. A 50 μl sample of the formulation to be tested is added to the Delta 8 plate. The Delta 8 instrumentation unit is calibrated in accordance with the calibration procedure described in the Delta 8 manual. The Delta 8 unit is then used to measure the surface tension in accordance with the measurement procedure described in the manual. The surface tension is measured 10 minutes after the sample is made and the measurement recorded.

SITA Foam Test Method

A SITA foam tester, model # 300135 (commercially available from Vor Offnen Netzstecker Ziehen of Dresdan, Germany) is used to determine the amount of foam generated from a sample that is exposed to agitation. The SITA Foam Tester will agitate a solution at a specified rpm and record the volume of foam produced by the solution. Several conductivity probes will touch the surface of the foam buildup to determine the volume. The known samples can be replicated and the values averaged to determine the foam height. An extended test to determine the averaged foam decay values can also be determined. The procedure is as follows:

Procedure:

1. Turn on computer desktop and SITA Foam Test Unit (if needed).

2. Open SITA Program on the desktop.

3. Clean the instrument before use:
a. Cleaning Solution Reservoir: Rinse solution reservoir thoroughly with deionized water and fill with approximately 200 ml of deionized water. Attach Solution In tubing to reservoir.
b. Cleaning Sample In tubing: In the SITA program, click Device and Manual to open the manual control window. Select Sample In and fill the test reservoir with the deionized water. Select Sample In again to stop. Next select Sample Out once to drain the test reservoir and once more to stop draining once the test reservoir is empty. Exit Manual window.
c. Remove any remaining deionized water from the solution reservoir and fill with sample solution. Repeat step 3b to clean the Sample In tubing.
d. Cleaning Test Reservoir: In the SITA program, click Device, Clean. A short cut for this function is located in the middle of the tool bar labeled as a shower. This will automatically clean and drain the test reservoir. Make sure the deionized water line is attached to the instrument.

4. Method Parameters
a. In the SITA program, select Measurement Parameters. This will open a separate window.
   i. Under Series Count enter the following:
      1. Number of Replicates: 3
      2. Volume used in each test: 250 ml
   ii. In the Foam Buildup field:
      1. Select the time Intervals: 10 seconds
      2. Stir Count: 30
      3. RPM: 1500 rpm.
   These values control the length of time the rotor spins, how many times it spins, and the speed of rotation. The probes will determine the foam volume after each time interval.
   iii. In the Foam Decay field:
      1. Select the time Intervals: 10 seconds
      2. Length of Decay: 5 minutes
      3. Minimum Volume: 0 mL.
   These controls determine the time between each foam reading, the amount of time the foam readings are taken, and the foam volume at which to stop the probe readings. Once the last revolution of the rotor has finished, the decay readings begin. With the settings in number iii above, the probes will measure the foam volume every 10 seconds for a total of 5 minutes or until the foam volume is at the selected minimum value of zero.
   iv. Check Clean in the Clean field to clean the test reservoir after each run.
   v. As temperature controls are not be used for this test, the Temperature box should not be checked.

5. Sample Run:
a. Make sure the solution reservoir has enough solution to perform each test including each of the replicates. An extra 150 ml will be needed to account for the Sample In tubing of the unit.
b. Press the Play button on the toolbar in the SITA program. This will open a table and begin the measurements. To stop, press the Stop button on the toolbar in the SITA program.

6. Close program.

Data Analysis:

a. All data from the SITA Foam Test unit are exported to an Excel spreadsheet.
b. The initial foam height and the foam decay after 2 minutes are recorded.
c.
   Method for Measuring Delivery Rate of the Spray Stream

The delivery rate of the spray stream is measured in accordance with the “Standard Test Method for Delivery Rate of Aerosols” found in the Chemical Specialties Manufacturing Association's CSMA Aerosol Guide-Eighth Edition, published in 1995, pages L-25 through L27.

Method for Determining Spray Angle of the Spray Stream

The following method may be used to measure the spray angle of the spray stream:

1. Assemble an Olympus i-Speed monochrome high speed video camera Assemble a halogen lamp to provide additional light when filming. Use a 12.5 mm lens to video tape the spray with high resolution. Align the video camera such that the field of view includes the discharge of the nozzle in the actuator and extends to at least 6 inches from the discharge midpoint of the nozzle in the actuator. Further, insure that the camera is aligned to capture the widest angle of the spray.

2. Actuate the spray from the aerosol can.

3. Video tape the spray stream at adequate frame speed to insure sharp spray stream images against a black background.

4. Insert single frame pictures of the spray into Microsoft Visio or Adobe Photoshop wherein the pictures are zoomed in to 400%.

5. To determine the spray angle using the picture from step 6, draw the vertical line corresponding to the point that is 4 inches (10.16 cm) from the discharge of the nozzle so as to intersect the top and bottom boundaries of the spray. From the point where the vertical line intersects the top boundary of the spray, draw a line back to the discharge midpoint of the nozzle of the sprayer. Repeat this process for the lower boundary of the spray (i.e.; from the point where the vertical line intersects the bottom boundary of the spray, draw a line back to the discharge midpoint of the nozzle of the sprayer. The spray angle of the spray stream is the internal angle formed by the intersection of these two lines at the nozzle discharge.

Method for Measuring Impact Pressure of the Spray stream

The following method may be used to measure the impact pressure of the spray stream:
1. Utilize a Chatillion DFS-250G force meter available from Itin Scale Company of Brooklyn, N.Y. Assemble the force meter with the 16 cm load cell extension rod. Position the meter such that the can may be sprayed at the end of the extension rod while the can is in a full upright and vertical position.
2. Direct the spray at the end of the rod from a distance of 5 cm. Spray at a right angle to the rod end surface along the longitudinal axis of the rod for 3 seconds.
3. Record the force maximum displayed on the instrument display screen in Newtons.
4. Calculate the impact area of the cone using the following procedure:
   a. Radius (R) of the spray cone at the area of impact (in mm)=50×tangent (spray angle/2)
   b. Impact Area (mm²)=π(R)²
4. Divide the force reading by the Impact Area to get an impact pressure in N/mm².
5. Convert the pressure reading from N/mm² to kPa by multiplying by 1000.

### EXAMPLES

A number of different aqueous stain removal formulations made in accordance with the present invention can be identified which have sufficient wetting characteristics and stain loosening characteristics such that when applied to the fabric in the highly directed stream as described in the present invention will not obscure the stain as it is being removed hence allowing the user to watch the on the spot dissipation/removal of the stain as the formulation is contacting the stain on the fabric. The parameters for achieving this include an aqueous stain removal formulation having a surface tension of about 45 dynes/cm or less, an initial SITA foam height of about 260 ml or less which decays to a foam height of about 25 ml or less within 2 minutes. Formulations within this range can be effectively sprayed at the delivery rate, spray angle, and impact pressure needed to provide on the spot stain removal while not obscuring the stain with excessive suds or foam formation during use.

### Example 1

A 59 mm diameter×201 mm diameter necked aluminum aerosol container from CCL Containers, Inc (Ontario), having a brimful capacity of 470 ml, is filled with 345 grams of a composition of formula A, as shown in Table 1. A standard male valve stem assembly consisting of a dip tube, a valve body having a 0.080 inch (2.03 mm) diameter, a valve spring, a valve stem gasket, a valve stem having a single 0.018 inch (0.46 mm) orifice, and an aluminum mounting cap is inserted into the can such that the mounting cup is sitting on the top of the can. The valve stem assembly consists of the following parts, which can be obtained from Precision Valve Corporation of Yonkers, N.Y., (part numbers also shown):

| | |
|---|---|
| Valve Mounting Cup: | 32-8900-15 |
| Valve Stem: | 04-5030-01 |
| Valve Stem Gasket: | 05-5110-51 (made of Buna-N) |
| Valve Spring: | 06-6040-00 |
| Valve Body: | 07-5180-00 |
| Dip Tube: | 09-2050-50: 8 2/32″ length |

The headspace of the can is evacuated to a vacuum pressure of about 15 inches (381 millimeters) of mercury and crimped to seal the mounting cup to the can using conventional can sealing equipment and procedures. 8.85 grams of Aeron A-85 propellant is added through the valve stem to pressurize the can, resulting in a can pressure of 72 psig (598 kPa) at 70° F. (21.1° C.) and 160 psig (1204 kPa) at 130° F. (54.4° C.). An ACCUSOL® non-mechanical breakup actuator, also obtained from Precision Valve Corporation, is fitted with a nozzle insert having a 0.013 inch (0.33 mm) diameter orifice (Part #11-8121-05) and attached to the mounting cup of the sealed aerosol container.

When actuated, the product delivers a spray stream with a mass delivery rate of 1.7 grams/sec, a spray angle of about 2.5°, and an impact pressure of about 14 kPa, all measured using the test methods described in the Test Method section of this disclosure. This product has a surface tension of about 26.7 dynes/cm² which enables it to wet the stain very well. However, because it also has an initial SITA foam height of about 0 mls, the liquid spray does not obscure the view of the stain during use. Consequently, the user can observe the on the spot stain removal obtained by using the product.

TABLE 1

| Examples | A | B | C | D | E | F | G |
|---|---|---|---|---|---|---|---|
| Ingredients | Wt % | Wt % | Wt % | Wt % | Wt % | Wt % | Wt % |
| Ethanol | 15 | 10 | 10 | 15 | 10 | 8 | 10 |
| Isopropanol | — | 8 | 8 | — | 8 | 4 | 8 |
| Dipropylene glycol n-butyl | 10 | 10 | 5.0 | 5.0 | 10 | 10 | 10 |
| ether* | | | | | | | |
| Propylene glycol n-butyl | — | — | 2.5 | 2.5 | — | | |
| ether* | | | | | | | |
| 1-t-butoxy-2-propanol* | — | — | 2.5 | 2.5 | 10 | | |
| Diethylene glycol ethyl ether* | | | | | | 5 | 10 |
| UCAR FILMER ® IBT* | | | | | | 5 | |
| Sodium Cumene Sulfonate | 2.25 | 2.25 | 2.5 | 2.5 | 2.5 | 2.25 | 2.5 |
| NEODOL ® 23-9 Surfactant | 0.01 | 0.01 | 0.05 | 0.01 | 0.05 | 0.05 | 0.05 |
| Silicone Antifoam (SAG 720)** | — | — | 0.02 | 0.02 | — | | |
| Silicone Antifoam (DC1520)*** | 0.02 | 0.02 | — | — | — | | |
| SILWET ® 7600*** | — | — | 2.0 | — | 2.0 | — | 2.0 |
| Sodium bisulfite | — | — | — | 1.0 | — | 1.0 | |
| Sodium Isoascorbate | — | — | 1.0 | — | 1.0 | — | 1.0 |
| Sodium chloride | — | — | 0.01 | — | 0.01 | 0.01 | 0.01 |
| Perfume | 0.15 | 0.3 | 0.3 | 0.15 | — | — | — |
| Water | Balance | Balance | Balance | Balance | Balance | Balance | Balance |
| Surface Tension (dynes/cm²) | 26.7 | 25.0 | 29.8 | NA | 30.0 | 31.8 | 30.7 |
| SITA Initial Foam Height | 0 | 0 | 90 | NA | 91 | 78 | 138 |
| (mls) | | | | | | | |
| Decayed Foam Height @ | 0 | 0 | 0 | NA | 0 | 0 | 36 |
| 2 min (mls) | | | | | | | |

*available from Dow Chemical Company of Midland, Michigan
**available from Dow Corning Corporation of Midland, Michigan
***available from GE Silicones of Wilton, Connecticut

### Example 2

The procedure of Example 1 is reproduced, except the can is filled with 345 grams of formula B. Under these conditions the product has a spray rate of 1.6 grams/sec, a spray angle of about 2.5°, and an impact pressure of about 14 kPa, all measured using the test methods described in the Test Method section of this disclosure. Again, because this product has a surface tension of 25 dynes/cm², and an initial SITA foam height of about 0 mls, it wets the stains well without obscuring the stain with foam when used. Consequently, the immediate effect of the product on the stain can be readily observed by the user while using the product.

### Example 3

The procedure of Example 1 is reproduced, with the exception that a valve stem having a 0.013″ (0.33 mm) orifice is used (Part number 04-5010-01 from Precision Valve Corporation) and a 0.018 inch (0.46 mm) reverse taper nozzle insert (Part number 11-0950-00 from Precision Valve Corporation) is used in the ACCUSOL® actuator. The other valve assembly parts are the same as Example 1.

Under these conditions the product has a spray rate of 2.0 grams/sec, a spray angle of about 4°, and an impact pressure of about 6.8 kPa, all measured using the test methods described in the Test Method section of this disclosure.

### Example 4

The procedure of Example 3 is reproduced, except the can is filled with 345 grams of formula C from Table 1.

Under these conditions the product has a spray rate of 2.1 grams/sec, a spray angle of about 4.5°, and an impact pressure of 6.5 kPa, all measured using the test methods described in the Test Method section of this disclosure.

### Example 5

The procedure of Example 1 is reproduced, with formulas D, E, F, and G from Table 1. The products have a surface tension and initial foam height as reported in Table 1. These products are also useful for removing stains.

While all the examples above provide the surprising stain removal benefits of the instant invention, those embodiments above having a higher impact pressure (e.g. Example 1), tend to yield the best stain removal results during use.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

What is claimed is:

1. A self-pressurized spray product for removing stains from textiles, said self-pressurized spray product comprising:
a) a pressurized dispensing container;
b) a propellant;
c) an aqueous stain removal formulation containing at least about 5% by weight of a non-aqueous solvent, at least about 30% by weight of water and having a surface tension of about 45 dynes/cm² or less, an initial SITA foam height of about 260 ml or less, and a decayed SITA foam height after 2 minutes of about 25 ml or less; and
d) an actuator having a nozzle and a valve stem assembly connected thereto whereby said aqueous stain removal formula is discharged from said pressurized dispensing container through said nozzle in the form of a spray, wherein the delivery rate of the spray from the nozzle is from about 0.25 g/sec to about 4 g/sec, wherein said spray at the discharge of said pressurized dispensing container forms a spray angle of about 10° or less, and wherein said spray has an impact pressure on the surface of the stain of about 1 kPa or more.

2. The self-pressurized spray product of claim 1 wherein said propellant sustains full can pressure at 70° F. of about 50 psig or more and about 40 psig or more after 75% of said aqueous stain removal formulation has been used.

3. The self-pressurized spray product of claim 1 wherein said solvent is an alcohol, a glycol, a glycol ether, an amine, an ester, a terpene, or mixtures thereof.

4. The self-pressurized spray product of claim 3 wherein said alcohol is a lower molecular weight alcohol containing from about 2 to about 4 carbon atoms.

5. The self-pressurized spray product of claim 1 wherein said aqueous stain removal formulation further comprises about 2% or less by weight of surfactant.

6. The self-pressurized spray product of claim 5 wherein said surfactant is a water soluble nonionic surfactant.

7. The self-pressurized spray product of claim 1 wherein said aqueous stain removal formulation further comprises from about 0.01% to about 15% by weight of a hydrotrope.

8. The self-pressurized spray product of claim 1 wherein said aqueous stain removal formulation further comprises from about 0.005% to about 1% by weight of a silicone antifoam agent.

9. The self-pressurized spray product of claim 1 wherein said aqueous stain removal formulation further includes a perfume, a reducing agent, a chelating agent, or mixtures thereof.

10. A system for removing stains from textiles, said system comprising:
a) a self-pressurized spray product, said self-pressurized spray product comprising:
i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less, and a decayed SITA foam height after 2 minutes of about 25 ml or less; and
iv) an actuator having a nozzle and a valve stem assembly connected thereto whereby said aqueous stain removal formula is discharged from said pressurized dispensing container through said nozzle in the form of a spray, wherein said spray delivers said aqueous stain removal formula from the nozzle to the stain at a rate of about 0.25 g/sec to about 4 g/sec; and
b) a washing appliance, a refreshing appliance, or a combination thereof.

11. The system of claim 10 wherein said washing appliance is a washing machine.

12. The system of claim 10 wherein said refreshing appliance is a refreshing cabinet.

13. A self-instructing article of commerce, said self-instructing article of commerce comprising:
a) a self-pressurized spray product for removing stains from textiles, said self-pressurized spray product comprising:
i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less, and a decayed SITA foam height after 2 minutes of about 25 ml or less; and
iv) an actuator having a nozzle and a valve stem assembly connected thereto whereby said aqueous stain removal formula is discharged from said pressurized dispensing container through said nozzle in the form of a spray, wherein said spray delivers said aqueous stain removal formula from the nozzle to the stain at a rate of about 0.25 g/sec to about 4 g/sec; and
b) a set of instructions, included in association with said self-pressurized spray product wherein said set of instructions directs a user to follow the method of removing stains from textiles with said self-pressurized spray product.

14. A method of removing stains from textiles said method comprising the steps of:
a) providing a self-pressurized spray product for removing stains from textiles, said self-pressurized spray product comprising:
i) a pressurized dispensing container;
ii) a propellant;
iii) an aqueous stain removal formulation containing at least about 5% by weight of a non-aqueous solvent and having a surface tension of about 45 dynes/cm² or less, an initial SITA foam height of about 260 ml or less and a decayed SITA foam height after 2 minutes of about 25 ml or less; and
iv) an actuator having a nozzle and a valve stem assembly connected thereto;
b) activating said actuator so as to discharge said aqueous stain removal formula in the form of a spray from said pressurized dispensing container through said nozzle at a rate of about 0.25 g/sec to about 4 g/sec;
c) contacting a textile stain with said spray wherein the impact pressure of said spray on the stain is about 1 kPa or more.

15. The method of claim 14 wherein said spray forms a spray angle of about 10° or less.
